(19) United States
(12) Patent Application Publication
(10) Pub. No.: US 2025/0368492 A1
(43) Pub. Date: Dec. 4, 2025

(54) METHOD FOR TRANSPORTING AND DEPOSITING A LOAD BY AN AUTONOMOUS FORKLIFT TRUCK

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); KEVIN BOUVET, Clermont-Ferrand (FR)

(21) Appl. No.: 18/876,120

(22) PCT Filed: Jun. 14, 2023
(86) PCT No.: PCT/FR2023/050867

§ 371 Date: Dec. 17, 2024

(30) Foreign Application Priority Data
Jun. 22, 2022 (FR) FR2206209

(51) Int. Cl. B66F 17/00; B66F 9/06; B66F 9/075

(52) U.S. Cl. CPC B66F 17/003; B66F 9/063; B66F 9/0755

(57) ABSTRACT

This autonomous lift truck (1) comprises: a lifting member (2) that can move at least vertically, a drive system (6), a first contactless detection device (9), which is fixed with respect to the truck and makes it possible to detect an obstacle situated in front of the truck, and a control unit (8), which can control the truck on the basis of the information from the first detection device, and can control the movement of the lifting member (2). The truck further comprises a second contactless detection device (11), which is fixed with respect to the truck (1), arranged above the first detection device (9) and can detect an obstacle situated in front of the truck (1). The control unit (8) can control the truck (1) on the basis of the information from the second contactless detection device (11).

### TECHNICAL FIELD

The present invention relates to the field of autonomous vehicles for the automated transportation of loads, such as autonomous lift trucks.

### PRIOR ART

Autonomous vehicles for transporting loads are being increasingly used to increase productivity and improve logistics management in factories or in warehouses.

Automated lift trucks are one example of such vehicles and make it possible for example for a load to be loaded, transported and positioned at height without human intervention.

However, in environments such as factories or warehouses, human intervention is still required in addition to the automated operations, for example to check that these operations are progressing correctly or to perform tasks that cannot be carried out by machines alone. These environments are therefore shared between humans and autonomous machines.

Personal safety is of fundamental importance in such working environments and accordingly requires specific procedures to be put in place.

For example, in order to limit the risk of a collision, autonomous lift trucks are conventionally equipped with devices for contactlessly detecting obstacles.

Such a contactless detection device is fixed to the truck and emits a light beam that is oriented towards the front in order to detect whether an obstacle is present in its detection field. When the presence of an obstacle is detected, the autonomous lift truck slows down, or even carries out an emergency stop.

During the phase of setting down a load, the lift truck approaches a storage structure until it reaches a setting-down position that allows the setting-down operation to be carried out. As the lift truck is approaching, the detection field of the contactless detection device has to be deactivated so that the structure is not detected thereby and does not prevent the setting-down position from being reached.

Therefore, there is a risk of a pedestrian being crushed between the load borne by the lift truck and the structure.

### DISCLOSURE OF THE INVENTION

In light of the above, the aim of the invention is therefore to propose an autonomous lift truck capable of increasing the level of safety of the operations of setting down a load.

The invention relates to an autonomous lift truck comprising a lifting member that can move at least vertically and is equipped with at least two arms for lifting loads, a drive system for moving the lift truck, a first contactless detection device, which is fixed with respect to the truck and can emit a first light beam having a main emission direction that is oriented horizontally towards the front of the lift truck in order to detect an obstacle situated in front of said truck.

According to one general feature, the lift truck further comprises a control unit, which can receive information indicative of the presence of an obstacle from the first contactless detection device, can control the operation of the drive system in order to autonomously guide the lift truck on the basis of the information from the first contactless detection device, and can control the movement of the lifting member.

According to another general feature, the lift truck further comprises a second contactless detection device, said second contactless detection device being fixed with respect to the truck and arranged above the first contactless detection device. The second contactless detection device can emit a second light beam having a main emission direction that is oriented horizontally towards the front of the lift truck in order to detect an obstacle situated in front of said truck.

According to another general feature, the control unit receives information indicative of the presence of an obstacle from the second contactless detection device.

According to another general feature, the control unit can control the operation of the drive system in order to autonomously guide the lift truck on the basis of the information from the second contactless detection device.

Such an autonomous lift truck makes it possible to ensure, during operations of setting down a load, that the vehicle approaches structures intended to receive loads without the risk of pedestrians being crushed.

Advantageously, the second contactless detection device is fixed to said lift truck at a constant height with respect to the ground of between 150 mm and 2000 mm. This is because the applicant has observed that the risk of a pedestrian being crushed increases with storage structures that fall within this height range.

Advantageously, the second contactless detection device is fixed to said lift truck at a height with respect to the ground of between 300 mm and 1100 mm, and preferentially of between 700 mm and 900 mm. By way of indication, the second contactless detection device may be fixed to said lift truck at a height with respect to the ground of equal to 830 mm. The autonomous lift truck comprises an on-board locator device, which is configured to acquire data relating to the position of the lift truck and communicates with the control unit. Preferably, the first and second contactless detection devices are distinct from the locator device.

According to one particular configuration, the light beam emitted by each of the first and second detection devices sweeps at least one predefined planar detection zone. The planar detection zone may be defined by four distinct points delimiting a rectangle, or by three distinct points delimiting a triangle. It is possible for the first and/or second detection devices to be provided with a light beam with a different planar shape, for example a circle, an ellipse, etc.

In a first embodiment, the lifting member is equipped with a fork that can move vertically and comprises said two arms.

In this case, the second contactless detection device may be offset towards the rear of said lift truck with respect to said two arms.

The fork of the lifting member may also further comprise at least two uprights each bearing one of said two arms. The second contactless detection device may then be offset towards the rear of said lift truck with respect to the uprights.

Said two arms of the fork can move between an uppermost position and a lowermost position that corresponds to a running position. Preferably, the first contactless detection device is fixed below said two arms in their lowermost position.

In an alternative second embodiment, the lifting member is equipped with a clamp that can move vertically, can rotate and comprises said two arms. In this case, the second contactless detection device may be offset towards the rear of said lift truck with respect to said two arms.

According to another aspect, the invention relates to a method for transporting and setting down a load using an autonomous lift truck as described hereinabove.

The transporting and setting-down method comprises:
a step of positioning the lift truck with respect to a structure intended to bear the load in an approach position with respect to said structure, the first contactless detection device being in an activated state during the step of positioning the truck,
when the truck has reached the approach position, a step of lifting the arms of the lifting member above the second contactless detection device, and a step of deactivating the first contactless detection device,
after the step of lifting the arms of the lifting member of the lift truck, a step of activating the second contactless detection device,
after the step of activating the second detection device, a step of advancing the autonomous lift truck as far as a setting-down position if no obstacle has been detected by the second contactless detection device,
a step of deactivating the second contactless detection device after the autonomous lift truck has reached the setting-down position, and
after or simultaneously with the step of deactivating the second contactless detection device, a step of lowering the arms of the lifting member of the lift truck in order to set down the load in the setting-down position.

This setting-down method improves the safety of the operators who are working or may be near the storage structures by making it possible to check that there is no operator between an autonomous lift truck transporting a load to be set down and a storage structure when the lift truck is approaching the structure during setting-down operations.

Preferably, when the lift truck has reached the approach position, the step of deactivating the first contactless detection device is performed after the step of lifting the arms of the lifting member above the second light beam of the second contactless detection device.

As an alternative, it is possible to perform the step of deactivating the first contactless detection device before the step of lifting the arms of the lifting member above the second light beam of the second contactless detection device.

### BRIEF DESCRIPTION OF THE DRAWINGS

Other aims, features and advantages of the invention will become apparent upon reading the following description, which is given solely by way of non-limiting example and with reference to the appended drawings in which:

FIG. 1 is a perspective view of an autonomous lift truck according to a first exemplary embodiment of the invention;

FIG. 2 FIG. 3 FIG. 4 and FIG. 5 schematically illustrate the lift truck from FIG. 1 during its use in a method for transporting and setting down a load according to one embodiment of the invention;

FIG. 6 illustrates the flow diagram for a method for transporting and setting down a load according to one embodiment of the invention; and

FIG. 7 is a perspective view of an autonomous lift truck according to a second exemplary embodiment of the invention.

### DETAILED DESCRIPTION OF AT LEAST ONE EMBODIMENT

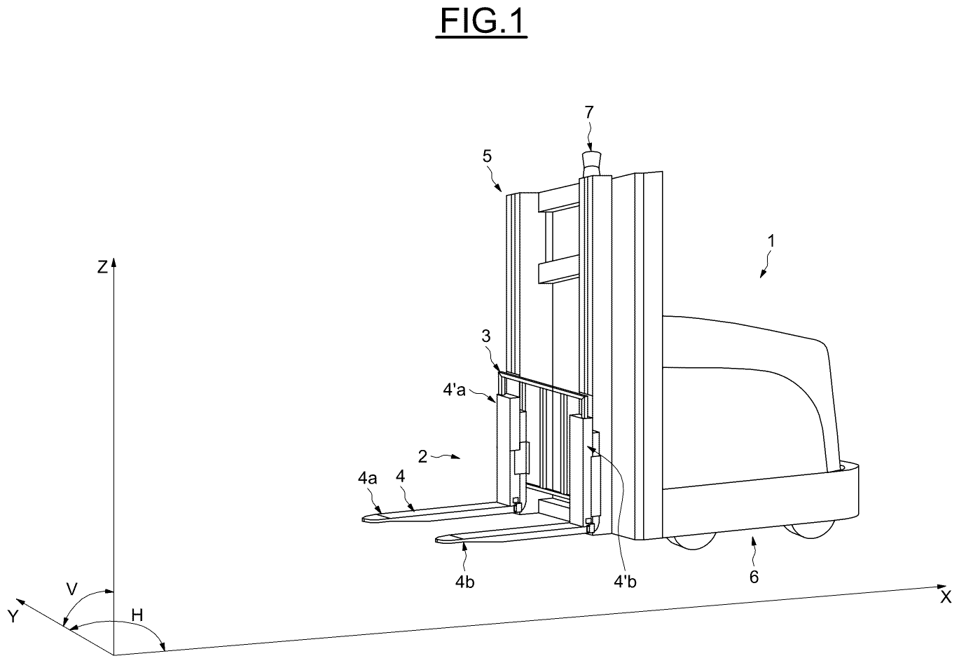

FIG. 1 depicts the main elements of an autonomous lift truck 1 according to one embodiment of the invention.

The architecture of the lift truck 1 is given by way of example and does not limit the invention to the architectural configuration presented alone. It must be understood that the invention also relates to lift trucks designed to operate in manual mode and which have been adapted to enable a second mode of operation in autonomous mode.

The autonomous lift truck 1 illustrated in FIG. 1 comprises a lifting member 2 comprising a carriage 3 and equipped with a fork 4 comprising two arms 4a, 4b that are spaced apart laterally and extend towards the front of the truck. The fork 4 also comprises two uprights 4′a, 4′b, which each bear one of the arms 4a, 4b.

The arms 4a, 4b of the fork are generally used for insertion into entry openings provided in the transport pallets bearing the loads to be raised. The uprights 4′a, 4′b allow the arms 4a, 4b to be raised so that a pallet that is to be transported or some other type of load can be raised and so that a pallet or some other type of load can be positioned or collected at height.

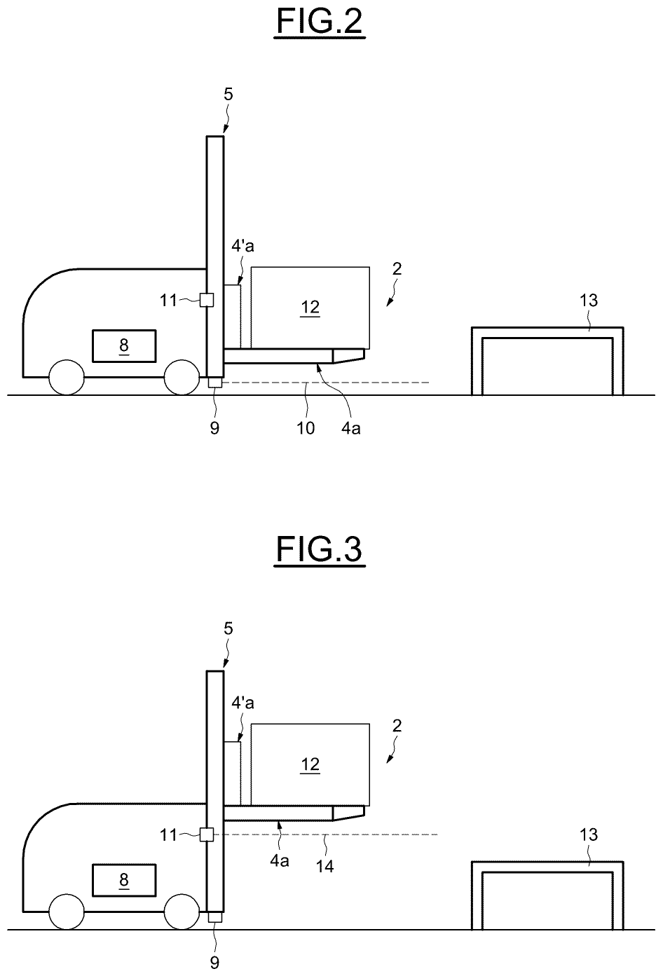

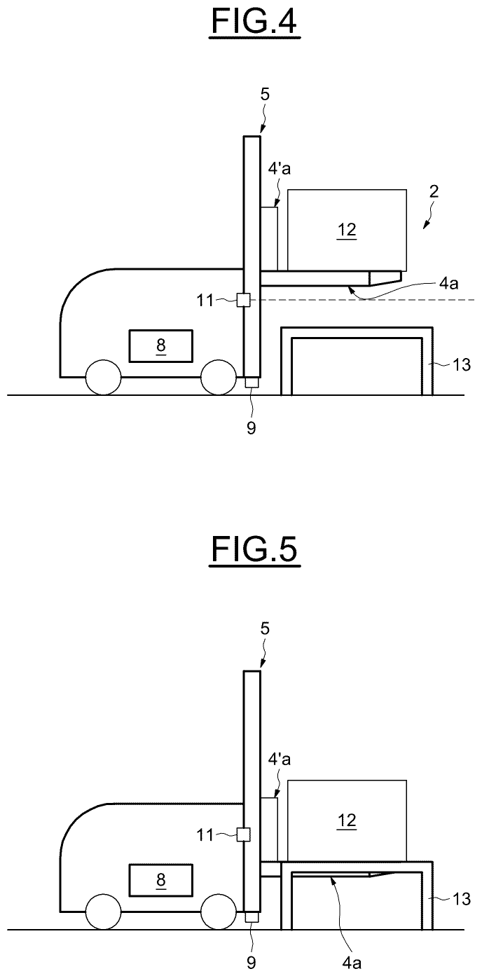

The fork 4 can move in translation in a vertical plane V defined by the carriage 3, along a vertical mast 5 of the truck. The uprights 4′a, 4′b are able to slide along the mast 5. The arms 4a, 4b of the fork can move between an uppermost position and a lowermost position that is illustrated in FIGS. 1 and 2 and that corresponds to a running position. In the lowermost position, the arms 4a, 4b are situated at a distance from the ground.

The longitudinal axes of the arms 4a, 4b of the fork 4 are parallel. These longitudinal axes are oriented parallel to a horizontal axis X and define a horizontal plane H referred to as the lifting plane. The arms 4a, 4b of the fork 4 are perpendicular to the vertical plane V. The arms 4a, 4b of the fork can preferably also move laterally with respect to one another.

As a variant, the arms of the fork 4 could also be telescopic or retractable and/or able to be oriented angularly about their longitudinal axis.

In a manner known per se, the truck 1 is equipped with a drive system 6 enabling the truck 1 to move. The drive system comprises at least one electric motor or combustion engine (not depicted) providing drive to the wheels of the truck 1.

The truck 1 is also equipped with an on-board locator device 7 and with an on-board control unit 8 (FIG. 2) receiving information from the locator device 7 in order to autonomously control the movement of the lift truck.

The control unit 8 comprises the hardware and software for controlling the operation of the drive system 6 on the basis of the information received from the locator device 7. The control unit 8 also makes it possible to control the autonomous movement of the lifting member 2.

The truck 1 is equipped with a first contactless detection device 9, which is fixed to the truck 1 without the possibility of relative movement with respect to said truck. The contactless detection device 9 is fixed at a constant height with respect to the ground. The contactless detection device 9 is situated below the arms 4a, 4b of the lifting member 2 in their lowermost position. The contactless detection device 9 is fixed to the truck 1. The contactless detection device 9 is fixed to the truck 1 without the possibility of relative movement in translation with respect to said truck. The contactless detection device 9 is situated below the mast 5 and is offset towards the rear of the lift truck with respect to the arms 4a, 4b and with respect to the uprights 4′a, 4′b.

The truck 1 is further equipped with a second contactless detection device 11, which is also fixed to the truck 1. The contactless detection device 11 is fixed to the truck 1 without the possibility of relative movement in translation with respect to said truck. The contactless detection device 11 is fixed at a constant height with respect to the ground. The contactless detection device 11 is arranged above the contactless detection device 9. The contactless detection devices 9, 11 respectively form lower and upper detection devices. The detection devices 9, 11 are distinct from one another. The detection devices 9, 11 are also distinct from the locator device 7. The detection devices 9, 11 may for example be lidar laser sensors.

The contactless detection device 11 is situated above the arms 4a, 4b of the lifting member 2 in their lowermost position. The contactless detection device 11 is fixed to the mast 5. The contactless detection device 11 is offset towards the rear of the lift truck with respect to the arms 4a, 4b and with respect to the uprights 4′a, 4′b.

The second contactless detection device 11 is arranged at a constant height with respect to the ground that may for example be between 150 mm and 2000 mm, and preferentially between 300 mm and 1100 mm, and even more preferentially between 700 mm and 900 mm. The second contactless detection device 11 may for example be arranged at a height equal to 830 mm.

As will be described in more detail hereinbelow, the detection devices 9, 11 can each emit a light beam having a main emission direction that is oriented horizontally towards the front of the lift truck 1 in order to detect an obstacle situated in front of said truck. The light beams emitted by the detection devices 9, 11 are distinct.

The detection devices 9, 11 are configured to acquire data relating to the presence of an obstacle, and to transmit to the control unit 8 information indicative of the presence of the obstacle detected inside at least one predefined detection zone. On the basis of the information received, the control unit 8 then controls the operation of the drive system 6 and the vertical movement of the lifting member 2. The control unit 8 also makes it possible to control the activated state or the deactivated state of each of the detection devices 9, 11.

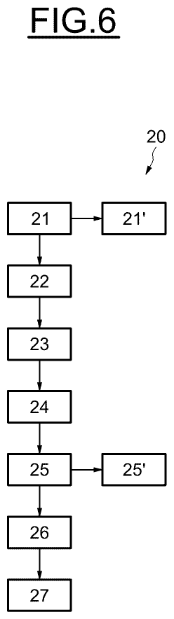

With reference to FIGS. 2 to 5, the principle of operation of the autonomous lift truck 1 for the operation of setting a load 12 down on a structure 13 and the associated setting-down method 20 illustrated in FIG. 6 will now be described.

The method 20 starts with the step 21 of positioning the lift truck 1 in an approach position predefined with respect to the structure 13 intended to bear the load.

In this initial phase, the control unit 8 controls the operation of the truck 1 in order to bring it closer to the structure 13 on the basis of the data from the locator device 7 and the information from the detection device 9. This positioning step 21 is performed in an activated state of the first contactless detection device 9, which emits a first light beam 10 oriented horizontally towards the front of the truck 1. If the presence of an obstacle situated in front of the truck 1 is detected by the detection device 9, the control unit 8 controls the truck 1 to carry out an emergency stop and the truck 1 to be placed on standby for an operator to re-establish correct operation (step 21′).

By contrast, if the first contactless detection device 9 does not detect any obstacles, the control unit 8 continues to cause the truck 1 to advance until it reaches the approach position.

When the truck 1 reaches the approach position, the method 20 continues with a step 22 of lifting the arms and a step 23 of deactivating the contactless detection device 9. The control unit 8 emits, for this purpose, an instruction to deactivate the contactless detection device 9 and an instruction to lift the arms 4a, 4b.

During the step 22, the movement of the arms is controlled by the control unit 8 so that they are situated above the contactless detection device 11 as illustrated in FIG. 3.

Preferably, the step 23 of deactivating the contactless detection device 9 is performed after the step 22 of lifting the arms 4a, 4b of the lifting member. Alternatively, the deactivation step 23 can be carried out before the step 22 of lifting the arms or simultaneously.

The method 20 continues with a step 24 of activating the contactless detection device 11. The control unit 8 emits, for this purpose, an instruction to activate the contactless detection device 11, which then emits a second light beam 14 (FIG. 3). The light beam 14 is situated below the arms 4a, 4b of the lifting member. In FIG. 3, the light beam 14 is situated above the structure 13.

After the step 24 of activating the detection device 11, the method 20 continues with a step 25 of advancing the lift truck 1 as far as a predetermined setting-down position.

If the contactless detection device 11 detects an obstacle, the control unit 8 controls the truck 1 to carry out an emergency stop and the truck 1 to be placed on standby for an operator to be able to re-establish correct operation (step 25′).

By contrast, if the second contactless detection device 11 does not detect any obstacles, the control unit 8 continues to cause the truck 1 to advance until it reaches said predetermined setting-down position.

When the truck 1 has reached said setting-down position, the method 20 continues with a step 26 of deactivating the contactless detection device 11. For this purpose, the control unit 8 emits an instruction to deactivate the contactless detection device 11.

The method 20 continues with a step 27 of lowering the arms 4a, 4b of the lifting member in order to set down the load in the setting-down position. The step 27 may be performed after the step 26 of deactivating the contactless detection device 11, or simultaneously with this step.

During this step 27, the control unit 8 controls the lowering of the arms 4a, 4b of the lifting member until the load 12 is placed in contact with the part of the structure 13 intended to receive it. The control unit 8 then continues to lower the arms 4a, 4b, causing a relative vertical movement between the arms 4a, 4b and the load 12, meaning that the latter is no longer in contact with the arms 4a, 4b and is resting entirely on the structure 13.

In the exemplary embodiment described, the lifting member of the lift truck is equipped with a fork that can move vertically and is equipped with the two arms 4a, 4b.

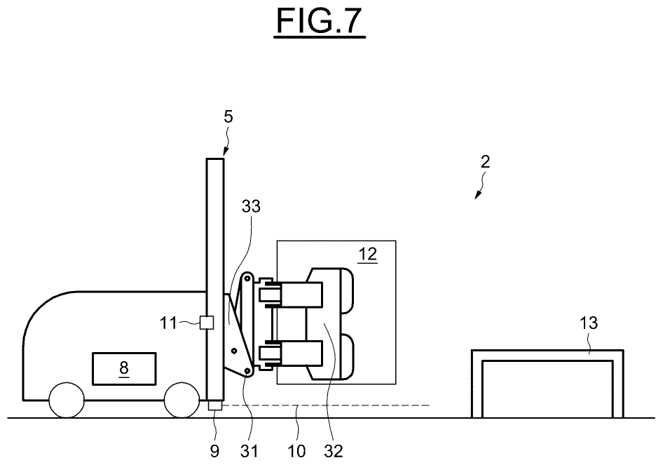

It does not constitute a departure from the scope of the invention if the lift truck is equipped, in place of the fork 4, with a clamp 30, as illustrated in FIG. 7 in which identical elements bear the same references. The clamp 30 of the lift truck can move vertically along the mast 5, can rotate about a horizontal axis 31 and is equipped with two arms 32 that can clamp the load to be set down, just one of the two arms being visible in FIG. 7.

In a manner known per se, the clamp 30 is equipped with a slider 33 that can slide along the mast 5 and bears the arms 32. The arms 32 of the clamp can move between an uppermost position and a lowermost position that corresponds to a running position. In the lowermost position, the arms 32 are situated at a distance from the ground.

In this case, the positioning of the detection devices 9, 11 is similar to that described above.

The contactless detection device 9 is fixed to the truck 1 in a similar manner to the first exemplary embodiment. The contactless detection device 9 is situated below the arms 32 of the clamp in their lowermost running position. The contactless detection device 9 is situated below the mast 5 and is offset towards the rear of the lift truck with respect to the arms 32 and with respect to the slider 33.

The contactless detection device 11 is also fixed to the truck 1 in a similar manner to the first exemplary embodiment. The contactless detection device 11 is arranged above the contactless detection device 9. The contactless detection device 11 is situated above the arms 32 of the clamp in their lowermost running position. The contactless detection device 11 is fixed to the mast 5. The contactless detection device 11 is offset towards the rear of the lift truck with respect to the arms 32 of the clamp and with respect to the slider 33.

1.-2. (canceled)

3. A method for transporting and setting down a load using an autonomous lift truck comprising a lifting member that can move at least vertically and is equipped with at least two arms for lifting loads; a drive system for moving the lift truck; a first contactless detection device, which is fixed with respect to the lift truck and can emit a first light beam having a main emission direction that is oriented horizontally towards a front of the lift truck in order to detect an obstacle situated in front of the lift truck; a control unit, which can receive information indicative of a presence of an obstacle from the first contactless detection device, can control operation of the drive system in order to autonomously guide the lift truck on a basis of the information from the first contactless detection device, and can control movement of the lifting member; and a second contactless detection device, which is fixed with respect to the lift truck and arranged above the first contactless detection device, the method comprising the following steps:
a step of positioning the lift truck with respect to a structure intended to bear the load in an approach position with respect to the structure, the first contactless detection device being in an activated state during the step of positioning the truck;
when the lift truck has reached the approach position, a step of lifting the arms of the lifting member above the second contactless detection device, and a step of deactivating the first contactless detection device;
after the step of lifting the arms of the lifting member of the lift truck, a step of activating the second contactless detection device;
after the step of activating the second contactless detection device, a step of advancing the autonomous lift truck as far as a setting-down position if no obstacle has been detected by the second contactless detection device;
a step of deactivating the second contactless detection device after the autonomous lift truck has reached the setting-down position; and
after or simultaneously with the step of deactivating the second contactless detection device, a step of lowering the arms of the lifting member of the lift truck in order to set down the load in the setting-down position.

4. The method according to claim 3, wherein, when the lift truck has reached the approach position, the step of deactivating the first contactless detection device is performed after the step of lifting the arms of the lifting member above a second light beam emitted by the second contactless detection device.
